(19) United States
(12) Patent Application Publication
(10) Pub. No.: US 2026/0109201 A1
(43) Pub. Date: Apr. 23, 2026

(54) SLIDING WINDOW AND VEHICLE

(71) Applicant: Fujian Fuyao Automotive Trim System Co.,Ltd., Fuqing (CN)

(72) Inventors: Fangmin Yu, Fuzhou (CN); Yonghui Lin, Fuzhou (CN); Shaoyi Qiu, Fuzhou (CN)

(21) Appl. No.: 19/357,368

(22) Filed: Oct. 14, 2025

(30) Foreign Application Priority Data
Oct. 18, 2024 (CN) 202411457763.9

(51) Int. Cl. B60J 1/16; B60J 1/20; B60J 10/76

(52) U.S. Cl. CPC B60J 1/16; B60J 1/2094; B60J 10/76

(57) ABSTRACT

A sliding window and a vehicle. The sliding window includes a frame, and an outer glass pane, and an inner glass pane. The frame is a circumferentially closed surrounding frame structure. The outer and inner glass panes are mounted in the frame. At least one selected from the inner and outer glass panes is slidable in the frame. The inner glass pane and/or the outer glass pane slidable in the frame is laminated glass. The laminated glass includes an outer glass plate, an intermediate layer and an inner glass plate which are sequentially stacked. An edge of the laminated glass is further provided with a protection mechanism.

### CROSS-REFERENCE TO RELATED APPLICATION

This application claims priority to Chinese Patent Application No. 202411457763.9, filed on Oct. 18, 2024, which is hereby incorporated by reference in its entirety.

### TECHNICAL FIELD

The present disclosure relates to the technical field of doors and windows, and particularly to a sliding window and a vehicle.

### BACKGROUND

Existing sliding window products primarily use tempered glass or insulating glass. Among these, sliding window products using tempered glass have poor noise reduction capabilities, while those using insulating glass also fail to meet users' increasingly higher demands for noise reduction performance. Overall, in the prior art, sliding window products made with the aforementioned types of glass cannot meet the requirements of scenarios with high demands for noise reduction performance.

In a scenario such as an automobile design structure, particularly for driver-side windows, the requirement for noise reduction performance is high. If the noise reduction effect of the driver-side window is poor, it can directly affect the driver's driving state. However, the existing tempered glass or insulating glass cannot meet the demands of some current scenarios requiring high glass noise reduction performance.

Therefore, it is necessary to propose a sliding window and a vehicle using the same to solve at least one of the above problems.

### SUMMARY

To address the deficiencies existing in the prior art, embodiments of the present disclosure provide a sliding window and a vehicle, which can effectively improve the noise reduction performance of the sliding window, thereby improving user experience.

The specific technical solutions of the embodiments of the present disclosure are as follows.

The embodiments of the present disclosure provide a sliding window, which includes a frame, an outer glass pane, and an inner glass pane. The frame is a circumferentially closed surrounding frame structure. The outer glass pane and the inner glass pane are mounted in the frame. At least one selected from the inner glass pane and the outer glass pane is slidable in the frame. The inner glass pane and/or the outer glass pane slidable in the frame is laminated glass. The laminated glass includes an outer glass plate, an intermediate layer and an inner glass plate which are sequentially stacked. An edge of the laminated glass is provided with a protection mechanism.

In an exemplarily embodiment, the edge of the laminated glass includes a top edge and a bottom edge opposite to each other, and a side edge connected to the top edge and the bottom edge. The protection mechanism includes an encapsulation that wraps the side edge.

In an exemplarily embodiment, the encapsulation is fixed on the side edge of the laminated glass by adhesion, and the encapsulation includes one or more selected from a metal encapsulation, an injection-molded encapsulation and a rubber encapsulation.

In an exemplarily embodiment, the sliding window further includes a window locking mechanism, which is connected to the laminated glass through the encapsulation.

In an exemplarily embodiment, the window locking mechanism includes a locking body and a connector. The locking body includes a locking block, which is connected to the encapsulation through the connector.

In an exemplarily embodiment, the laminated glass is provided with an adhesive layer of a predetermined size at a position close to the encapsulation. Part of the locking block is connected to the adhesive layer, and another part of the locking block extends to the encapsulation. A hole for being matched with the connector is formed at positions of the locking block and the encapsulation that are overlapped with each other.

In an exemplarily embodiment, the frame includes a top pillar and a bottom pillar opposite to each other, and a side pillar connecting the top pillar and the bottom pillar. The sliding window further includes a sealing mechanism for sealing between the laminated glass and the frame. The top pillar of the frame is provided with a top mounting groove, and the side pillar is provided with a side mounting groove. The sealing mechanism includes a top seal disposed between the top mounting groove and a top edge of the laminated glass, and a side seal disposed between the side mounting groove and a side edge of the laminated glass.

In an exemplarily embodiment, the frame further includes a middle pillar, and the sealing mechanism further includes a middle pillar sealing assembly. The middle pillar sealing assembly is disposed at a butting position between the outer glass pane and the inner glass pane, to seal a gap between the outer glass pane and the inner glass pane when the sliding window is in a closed state.

In an exemplarily embodiment, the middle pillar sealing assembly includes a middle pillar seal and a herringbone seal. The top pillar is provided with a first middle pillar mounting hole, the bottom pillar is provided with a second middle pillar mounting hole, and two ends of each of the middle pillar and the middle pillar seal are inserted into the first middle pillar mounting hole and the second middle pillar mounting hole, respectively. The middle pillar is provided with two first seal mounting portions in a second direction for mounting the middle pillar seal, respectively, and the second direction is consistent with a thickness direction of the inner glass pane or the outer glass pane. At least one side of the middle pillar in a first direction is provided with a second seal mounting portion for mounting the herringbone seal.

In an exemplarily embodiment, the frame includes a top pillar and a bottom pillar opposite to each other, and a side pillar connecting the top pillar and the bottom pillar. The bottom pillar is provided with a lower guide mechanism for guiding movement of the laminated glass. The laminated glass is slidable along an extension direction, which is a first direction, of the bottom pillar under guidance of the lower guide mechanism.

In an exemplarily embodiment, the lower guide mechanism includes an engaging strip disposed on the bottom pillar and extending longitudinally along the first direction, and a top of the engaging strip is arc-shaped. The protection mechanism further includes a guide assembly which is disposed on a bottom edge of the laminated glass and configured to cooperate with the lower guide mechanism. The guide assembly includes a guide groove connector and an end slider. The guide groove connector extends longitudinally along the first direction, a top of the guide groove connector is provided with a top mounting groove for being matched with the laminated glass, and a bottom of the guide groove connector is provided with a bottom mounting groove. The end slider is detachably disposed in the bottom mounting groove of the guide groove connector. A lower end of the end slider is provided with an arc groove engaged with the top of the engaging strip. The end slider is movable along the first direction relative to the engaging strip.

In an exemplarily embodiment, the lower end of the end slider is provided with a hook at a position of the arc groove, the hook and the top of the engaging strip are clearance-fitted, and a movement clearance between the hook and the top of the engaging strip in a height direction is less than or equal to 0.5 mm.

In an exemplarily embodiment, the frame includes a bottom pillar formed with a hollow cavity, and the cavity is provided with a return flow portion for guiding water into the cavity and a drainage hole for draining water out of the cavity. The return flow portion, the cavity and the drainage hole are communicated to form a drainage passage.

In an exemplarily embodiment, the cavity has an outer surface exposed to the outside, and the drainage hole is disposed on the outer surface. The sliding window further includes a cover covering the drainage hole, and the cover cooperates with the bottom pillar to define a non-return passage, so that the water discharged from the drainage hole flows through the non-return passage and is directed outwardly in a direction away from the drainage hole.

In an exemplarily embodiment, an inner surface of the cover is provided with a plurality of groups of block structures, which are staggered at intervals along a height direction. The block structure includes sealing block bars which are obliquely disposed, and a drainage outlet is formed between any two adjacent sealing block bars and directly opposite to the sealing block bar located below it.

In an exemplarily embodiment, the bottom pillar is provided with a lower guide mechanism for guiding movement of the laminated glass. The bottom pillar is provided with a baffle, and the protection mechanism further includes a guide assembly disposed on a bottom edge of the laminated glass for being matched with the lower guide mechanism. The guide assembly includes a guide groove connector which extends longitudinally along a first direction, and a guide groove seal is disposed between the guide groove connector and the baffle.

In an exemplarily embodiment, a side mounting groove is disposed on a side of the guide groove connector facing the baffle, the guide groove seal is disposed in the side mounting groove, and the guide groove seal is in interference fit with the baffle.

In an exemplarily embodiment, both the outer glass pane and the inner glass pane are slidable along the first direction in the frame, the frame comprises a side pillar that includes a first side pillar and a second side pillar disposed opposite to each other, and the frame further comprises a middle pillar located between the first side pillar and the second side pillar. The baffle includes a first baffle and a second baffle which extend longitudinally along the first direction and are spaced apart from each other. The first baffle has one end close to the first side pillar and the other end close to the middle pillar. The second baffle has one end close to the second side pillar and the other end close to the middle pillar. When the sliding window is in a closed state, the first baffle is directly opposite to the guide groove connector of the outer glass pane through the guide groove seal, and the second baffle is directly opposite to the guide groove connector of the inner glass pane through the guide groove seal.

In an exemplarily embodiment, the lower guide mechanism includes a engaging strip disposed on the bottom pillar, the engaging strip includes an outer engaging strip for being matched with the outer glass pane and an inner engaging strip for being matched with the inner glass pane. The inner engaging strip, the baffle and the outer engaging strip are spaced apart from inside to outside to define a first groove, a second groove, and a third groove. The return flow portion includes a first return flow hole and a second return flow hole which are located on the bottom pillar and at least partially shielded by the first side pillar. The first return flow hole communicates the first groove with the cavity, and the second return flow hole communicates the second groove with the cavity.

In an exemplarily embodiment, the first return flow hole and the second return flow hole are integrally formed as a communication hole on an upper surface of the cavity, and the communication hole is enclosed in a surrounding structure formed by the first side pillar and the inner engaging strip.

In an exemplarily embodiment, the return flow portion further includes a third return flow hole located on a bottom wall of the second groove and disposed close to the second side pillar, and the third return flow hole is enclosed in a surrounding structure formed by the guide groove seal, the baffle and the outer engaging strip.

In an exemplarily embodiment, the return flow portion further includes a fourth return flow hole located on a bottom wall of the first groove.

In an exemplarily embodiment, the fourth return flow hole and the third return flow hole are staggered with the drainage hole in the first direction.

In an exemplarily embodiment, a distance between the fourth return flow hole and the drainage hole in the first direction is greater than a distance between the third return flow hole and the drainage hole in the first direction.

In an exemplarily embodiment, the outer engaging strip is provided with a water accumulation hole at a position close to a bottom wall of the third groove.

Embodiments of the present disclosure further provide a vehicle including a body sheet metal and the sliding window according to any one of the above embodiments. The body sheet metal is provided with a sliding window mounting opening where the sliding window is mounted.

The technical solutions of the present disclosure have the following remarkable advantageous effects.

The sliding window according to the embodiments of the present disclosure overcomes the technical barrier of the laminated glass. By using the laminated glass with better noise reduction performance as the glass of the sliding window, the noise reduction performance of the sliding window can be enhanced, and the user experience can be improved. In addition, by disposing the protection mechanism at the periphery of the laminated glass, the laminated glass is effectively protected to reduce the risk of cracking.

By disposing the encapsulation for the side edge of the laminated glass, not only the laminated glass can be effectively protected, but also the use reliability of the laminated glass can be improved to reduce the risk of cracking. Meanwhile, the window locking mechanism of the laminated glass is ingeniously disposed through the encapsulation, which overcomes the technical obstacles that the laminated glass cannot be punched and the window locking mechanism cannot be disposed in the prior art.

By improving the matching structure between the frame 100 and the laminated glass, the movable gap of the laminated glass in the height direction is reduced to be within 0.5 mm, so that the wobble amount of the laminated glass in the height direction can be effectively decreased, and the noise that may be generated by the sliding window can be effectively reduced. In addition, when the wobble amount of the laminated glass in the height direction is reduced to less than 0.5 mm, the movement stroke of the laminated glass is effectively shortened, which is also beneficial to protecting the laminated glass and preventing the laminated glass from cracking due to repeated impacts with a large stroke.

In addition, in the embodiments of the present disclosure, by optimizing and improving the sealing mechanism and the drainage passage in the sliding window, it is possible to further enhance the sealing performance of the sliding window, while achieving effective drainage in the scenarios of high-pressure washing and preventing the backflow water from splashing into the vehicle when the water backflow under the action of wind pressure. On the whole, when the sliding window according to the embodiments of the present disclosure undergoes high-pressure washing, the high-pressure washing resistance can be above 6 MPa.

With reference to the following description and drawings, specific embodiments of the present disclosure are disclosed in detail, and the ways in which the principles of the present disclosure can be adopted are pointed out. It should be understood that the scope of the embodiments of the present disclosure is not limited thereby. Embodiments of the present disclosure include many changes, modifications and equivalents within the spirit and scope of the appended claims. Features described and/or illustrated for one embodiment may be used in one or more other embodiments in the same or similar way, and combined with or substituted for features in other embodiments.

### BRIEF DESCRIPTION OF THE DRAWINGS

The drawings described here are for explanatory purposes only and are not intended to limit the scope of the present disclosure in any way. In addition, the shapes and proportional dimensions of the components in the drawings are only schematic, which are used to help understand the present disclosure, and do not specifically limit the shapes and proportional dimensions of the components in the present disclosure. Under the teaching of the present disclosure, persons skilled in the art can select various possible shapes and proportional dimensions to implement the present disclosure according to specific conditions.

FIG. 1 illustrates a structural diagram of a sliding window in a closed state according to an embodiment of the present disclosure;

FIG. 2 illustrates an exploded view of a sliding window according to an embodiment of the present disclosure;

FIG. 3 illustrates a structural diagram of an inner glass pane of a sliding window according to an embodiment of the present disclosure;

FIG. 4 illustrates a structural diagram of an outer glass pane of a sliding window according to an embodiment of the present disclosure;

FIG. 5 illustrates a front view of a sliding window in a closed state according to an embodiment of the present disclosure;

FIG. 6 illustrates a cross-sectional view taken along line A-A in FIG. 5;

FIG. 7 illustrates a cross-sectional view taken along line B-B in FIG. 5;

FIG. 8 illustrates a cross-sectional view taken along line C-C in FIG. 5;

FIG. 9 illustrates a partially enlarged view at D in FIG. 6;

FIG. 10 illustrates a partially enlarged view at E in FIG. 8;

FIG. 11 illustrates a structural diagram of a bottom pillar of a sliding window according to an embodiment of the present disclosure;

FIG. 12 illustrates a partially enlarged view at F in FIG. 11;

FIG. 13 illustrates a structural diagram of a bottom pillar and a first side pillar of a sliding window according to an embodiment of the present disclosure;

FIG. 14 illustrates a partially enlarged view at G in FIG. 13;

FIG. 15 illustrates a structural diagram of a cover of a sliding window according to an embodiment of the present disclosure; and

FIG. 16 illustrates a front view of a cover of a sliding window according to an embodiment of the present disclosure.

Reference numerals in the drawings:
100: frame; 110: top pillar; 120: bottom pillar; 130: first side pillar;
140: second side pillar; 150: middle pillar;
151: first seal mounting portion; 152: second seal mounting portion;
1301: first extension wall; 1302: second extension wall; 1303: side bottom wall;
200: outer glass pane; 300: inner glass pane;
400: window locking mechanism; 401: locking block; 402: rivet;
403: adhesive layer; 501: top seal; 502: side seal; 503: middle pillar seal;
504: herringbone seal; 505: guide groove seal; 610: encapsulation;
620: guide groove connector; 630: end slider; 6301: hook;
121: inner engaging strip; 122: outer engaging strip; 123: first baffle; 124: second baffle;
160: cavity; 161: drainage hole; 171: first groove; 172: second groove; 173: third groove;
181: first return flow hole; 182: second return flow hole; 183: third return flow hole;
184: fourth return flow hole; 185: water accumulation hole;
700: cover; 710: sealing block bar; 720: drainage outlet;
X: first direction; Y: second direction.

### DETAILED DESCRIPTION OF THE EMBODIMENTS

The technical solutions of the present disclosure will be described in detail below with reference to the drawings and the specific embodiments. It should be understood that these embodiments are only used to illustrate the present disclosure rather than limiting the scope of the present disclosure. After reading the present disclosure, persons skilled in the art can make various equivalent modifications to the present disclosure, which all fall within the scope defined by the appended claims of the present disclosure.

A laminated glass includes an outer glass plate, an intermediate layer and an inner glass plate which are sequentially laminated. The laminated glass has superior noise reduction performance.

Sliding windows often integrate a window locking mechanism to enable the sliding of glass panes. One feasible method is to drill holes in the glass pane to secure the window locking mechanism. However, for the laminated glass structure, drilling holes in both the outer and inner glass plates make it difficult to align the holes during the lamination process. However, in production practice, it has been found that aligning the holes during lamination is difficult to meet tolerance requirements, easily leading to a high rate of defective products.

The laminated glass structure also has a problem of being more prone to cracking when its side edge is subjected to impact compared to a single-piece glass plate structure with the same total thickness.

The present disclosure provides a sliding window and a vehicle using the same, which can significantly improve the noise reduction performance of the sliding window, thereby improving the user experience.

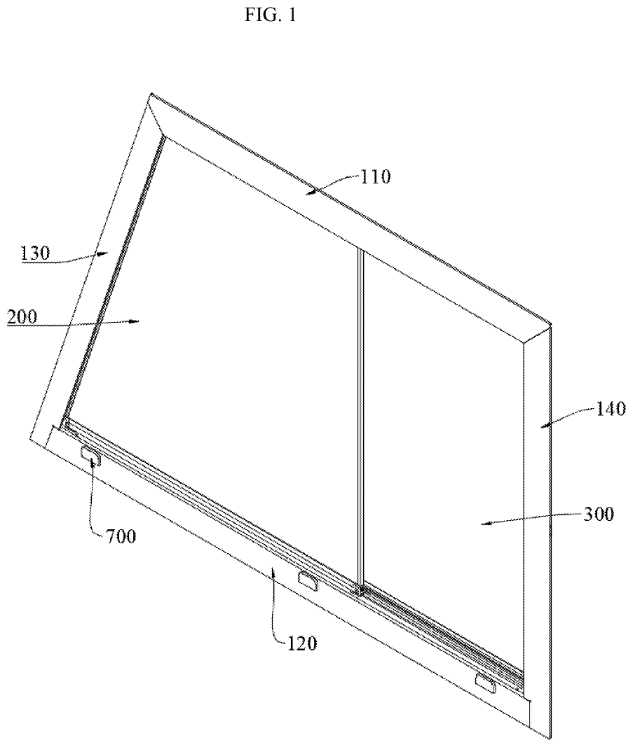

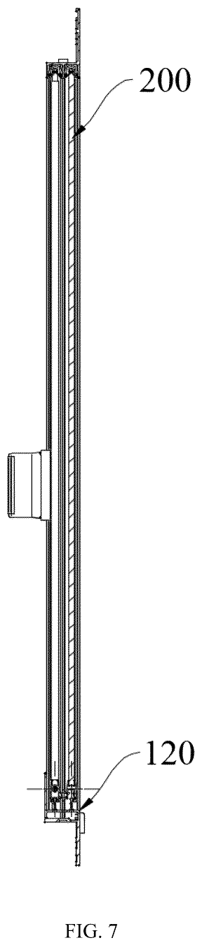

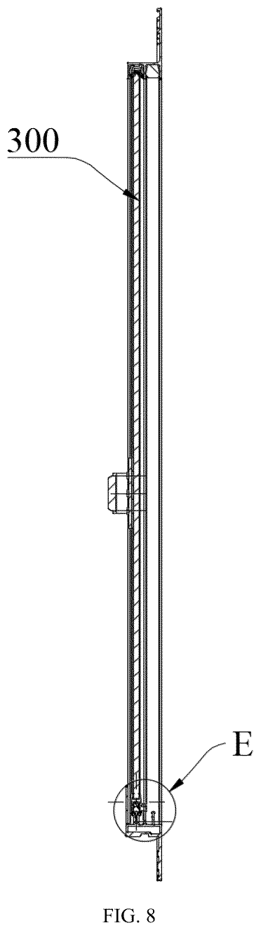

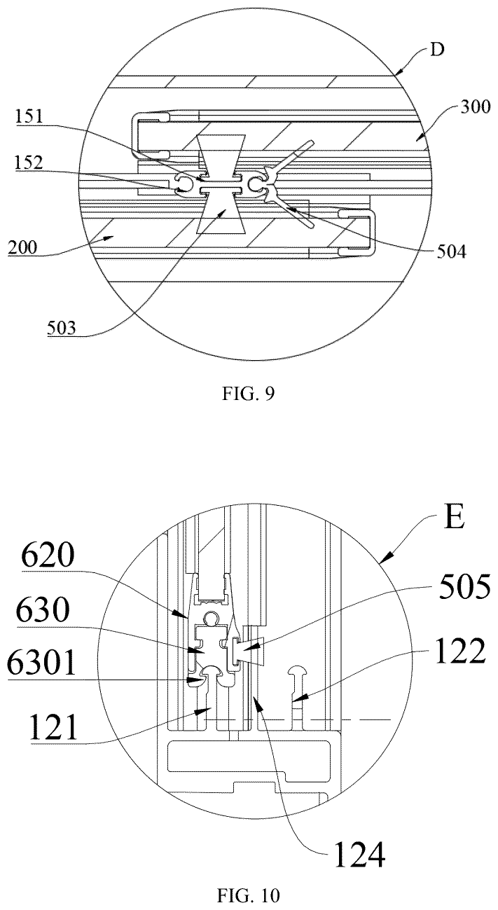

Referring to FIGS. 1 to 16, the embodiments of the specification of the present disclosure provide a sliding window, which may include a frame 100, and an outer glass pane 200 and an inner glass pane 300 that are mounted in the frame 100.

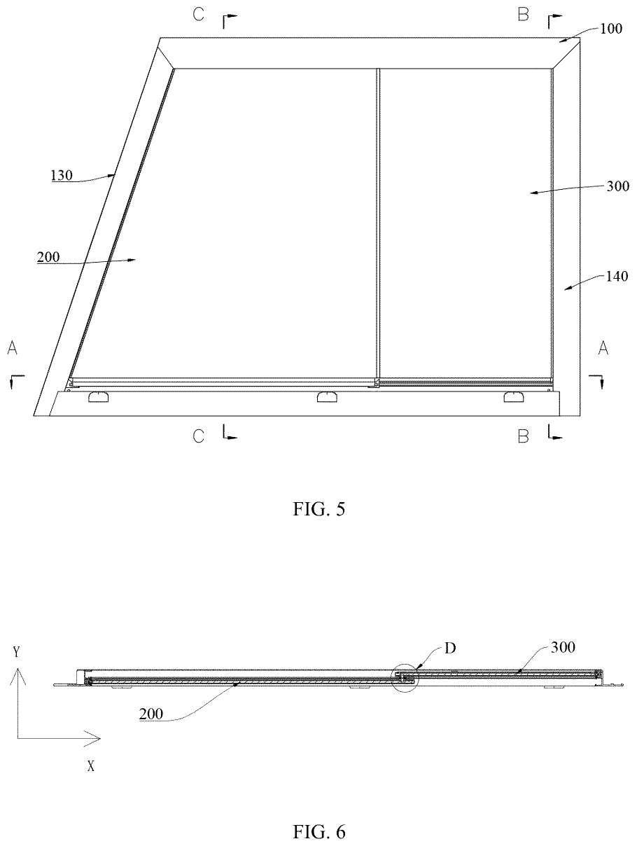

In the embodiments of the present disclosure, the frame 100 is a circumferentially closed surrounding frame structure. The frame 100 includes a top pillar 110 and a bottom pillar 120 opposite to each other, and a side pillar connecting the top pillar 110 and the bottom pillar 120. In a travelling direction of the vehicle, the side pillar may include a first side pillar 130 located on the left (from the perspective illustrated in FIG. 1 or 5) and a second side pillar 140 located on the right (from the perspective illustrated in FIG. 1 or 5). In this embodiment, the first side pillar 130, the top pillar 110, the bottom pillar 120 and the second side pillar 140 are sequentially connected end to end to form a quadrilateral structure which is circumferentially closed. The quadrilateral structure may be a right trapezoid, a rectangle, or any other configuration. The specific configuration of the quadrilateral structure may be comprehensively determined according to the shape, size, etc. of the object it is mounted on. In some special window application environments, the frame 100 may also have any other variable configuration. In the embodiments of the present disclosure, the frame 100 is mainly described as a quadrilateral structure. When the frame 100 has other configurations, adaptive adjustments can be made with reference to this embodiment, which will not be elaborated here.

In the embodiments of the present disclosure, at least two glass panes may be mounted in the frame 100, including the outer glass pane 200 and the inner glass pane 300. Taking the application of the sliding window in the vehicle as an example, the outer glass pane 200 is closer to the exterior of the vehicle than the inner glass pane 300. In the embodiments and the drawings of the present disclosure, the description mainly takes the frame 100 including one outer glass pane 200 and one inner glass pane 300 as an example for illustration. When the frame 100 includes more glass panes, adaptive adjustments can be made with reference to this embodiment, which will not be elaborated here.

At least one selected from the inner glass pane 300 and the outer glass pane 200 is slidable in the frame 100. For example, both the inner glass pane 300 and the outer glass pane 200 are movable glass which can slide in the frame 100 respectively, or one of them is movable glass while the other is fixed glass. In the embodiments and the drawings of the present disclosure, a case where both the inner glass pane 300 and the outer glass pane 200 are movable glass is taken as an example for illustration.

In order to improve the noise reduction performance of the sliding window, the inner glass pane 300 and/or the outer glass pane 200 which is slidable in the frame 100 may be configured as laminated glass. Specifically, the laminated glass includes an outer glass plate, an intermediate layer, and an inner glass plate which are sequentially stacked. When both the inner glass pane 300 and the outer glass pane 200 are laminated glass, the thickness combination for the laminated glass used as the inner glass pane 300 or the outer glass pane 200 may be as follows.

Combination 1: 2.1 mm inner glass plate+0.76 mm adhesive layer (e.g., PVB)+2.1 mm outer glass plate. When the laminated glass adopts this thickness combination, the overall thickness of the laminated glass is about 5 mm, which is similar to the existing sliding window glass, thereby effectively reducing changes in the structure and dimensions of the matching frame 100.

In addition, the thickness combination for the laminated glass may be of any other combination form, such as:

Combination 2: 2.5 mm inner glass plate+0.76 mm adhesive layer (e.g., PVB)+2.5 mm outer glass plate; or,

Combination 3: 3.0 mm inner glass plate+0.76 mm adhesive layer (e.g., PVB)+3.0 mm outer glass plate.

Of course, the thickness combination for the laminated glass is not limited to the above description. Under the inspiration of the technical essence of the present disclosure, persons skilled in the art can make other changes, as long as the achieved functions and effects are the same as or similar to those of the present disclosure, and those changes should fall within the protection scope of the present disclosure.

In some embodiments, the bottom pillar 120 of the frame 100 is provided with a lower guide mechanism for guiding movement of the laminated glass, and the laminated glass is slidable along an extension direction, which is a first direction X, of the bottom pillar 120 under the guidance of the lower guide mechanism.

The lower guide mechanism may include an engaging strip, which is disposed on the bottom pillar 120 and extended longitudinally along the first direction X. Correspondingly, a bottom edge of the laminated glass is provided with a guide assembly matched with the engaging strip. When a pushing or pulling force is applied to the laminated glass, the guide assembly moves relative to the engaging strip, so as to switch the sliding window between open and closed states.

The specific forms of the lower guide mechanism and the guide assembly are not limited to the above examples, and in the embodiments of the present disclosure, a typical way of sliding fit is mainly taken as an example for illustration.

The extension direction of the bottom pillar 120 is the first direction X. When the sliding window is applied as the driver's window, the first direction X is usually the direction in which the vehicle travels.

Side edges of the inner glass pane 300 and the outer glass pane 200 may be damaged by impact during sliding. In particular, when the inner glass pane 300 and the outer glass pane 200 are laminated glass, the glass itself is fragile. In order to prevent the side edge of the laminated glass from being cracked by impact when the window is opened and closed, a protection mechanism is provided at the edge of the laminated glass.

In some embodiments, the edge of the laminated glass may include a top edge and a bottom edge opposite to each other, and a side edge connected to the top edge and the bottom edge. The protection mechanism may include an encapsulation 610 that wraps the side edge.

Specifically, the encapsulation 610 may be fixed on a side of the laminated glass by adhesion, and the encapsulation 610 may include one or more selected from a metal encapsulation, an injection-molded encapsulation and a rubber encapsulation.

Since the encapsulation 610 is directly exposed to the external environment when mounted on the sliding window, considering factors such as durability and long-lasting appearance, the encapsulation 610 may be a metal encapsulation. Specifically, the encapsulation 610 may be an aluminum encapsulation made of an aluminum alloy profile, which offers mature manufacturing processes, controllable costs and excellent durability.

In some embodiments, the sliding window may further include a window locking mechanism 400, which is connected to the laminated glass through the encapsulation 610.

In this embodiment, the encapsulation 610 on the side edge of the laminated glass is ingeniously used for the installation of the window locking mechanism 400. The sliding window according to the embodiments of the present disclosure does not require drilling holes in the laminated glass structure, improving the yield rate of sliding window production.

Considering the need to use the encapsulation 610 for the installation and fixation of the window locking mechanism 400, the encapsulation 610 may be an aluminum encapsulation to ensure installation reliability.

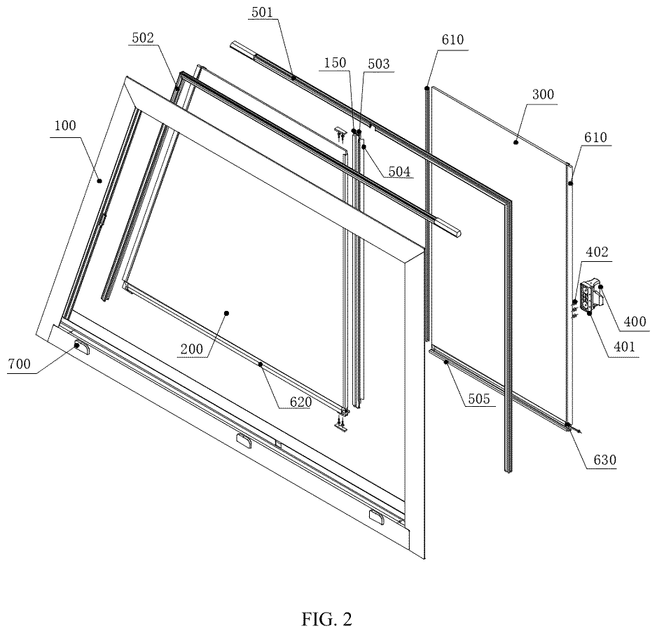

Referring to FIGS. 2, 3 and 4, specifically, the window locking mechanism 400 includes a locking body and a connector. The locking body includes a locking block 401, which is connected to the encapsulation 610 through the connector.

In addition to the locking block 401, the locking body may also include a window lock with a locking hook. The locking block 401 may be connected to the window lock by either detachable connection or fixed connection. When the window lock and the locking block 401 are made of different materials or have different replacement frequencies, the window lock may be connected to the locking block 401 by detachable connection, so that it is convenient for individual replacement.

When the window locking mechanism 400 is directly adhered to the glass surface, the adhesive area is small, the adhesive force is weak and the reliability is low. To improve the overall connection strength and ensure the connection reliability, in this embodiment, an adhesive layer 403 is disposed at a position on the side edge of the laminated glass where the window locking mechanism 400 is to be mounted, and the adhesive layer 403 is used to adhere both the encapsulation 610 and the locking block 401 to the laminated glass.

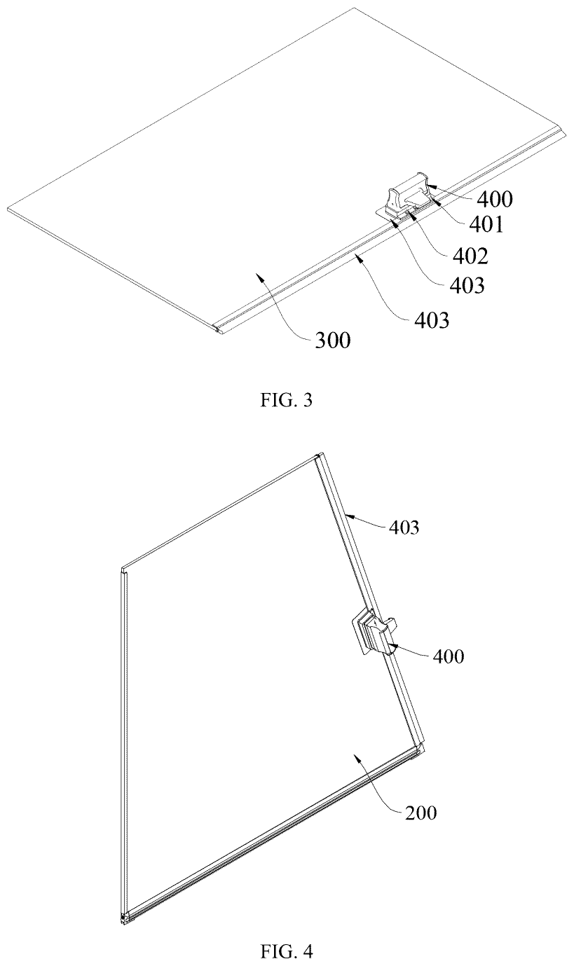

As illustrated in FIG. 3, in an embodiment, the laminated glass is provided with an adhesive layer 403 of a predetermined size (e.g., 2 mm or more) at a position close to the encapsulation 610. Part of the locking block 401 is connected to the adhesive layer 403, another part of the locking block 401 extends to the encapsulation 610, and a hole for being matched with the connector is formed at positions of the locking block 401 and the encapsulation 610 that are overlapped with each other.

Specifically, part of the locking block 401 extends beyond the side edge of the laminated glass and overlaps with the encapsulation 610, and the connector may be disposed at the overlapping positions of the locking block 401 and the encapsulation 610. Specifically, the connector may be in the form of a rivet 402. Of course, the form of the connector is not limited to the above example, and any other form is possible, which is not uniquely limited herein.

There may be a plurality of the connectors, which may be disposed at intervals along an extension direction of the encapsulation 610. For example, there may be three connectors which are disposed along the extension direction of the encapsulation 610 at equal intervals. Alternatively, the number of the connectors may be more or less, which is not specifically limited herein.

As illustrated in FIGS. 3 and 4, for the case where both the outer glass pane 200 and the inner glass pane 300 are movable glass panes, the outer glass pane 200 and the inner glass pane 300 are each provided with the window locking mechanism 400. Specifically, for example, along the traveling direction of the vehicle, when the outer glass pane 200 is disposed on the left (from the perspective illustrated in FIG. 1 or 5) and the inner glass pane 300 is disposed on the right (from the perspective illustrated in FIG. 1 or 5), a left side edge of the outer glass pane 200 is provided with the window locking mechanism 400, and the first side pillar 130 of the frame 100 is provided with a lock catch mechanism matched with the window locking mechanism 400; and a right side edge of the inner glass pane 300 is provided with the window locking mechanism 400, and a second side pillar 140 of the frame 100 is provided with a lock catch mechanism matched with the window locking mechanism 400.

As illustrated in FIG. 2, in the embodiments of the present disclosure, the sliding window may further include a sealing mechanism for sealing between the outer glass pane 200, the inner glass pane 300 and the frame 100. In some embodiments, the sealing mechanism may include a top seal 501 at the top pillar 110, a side seal 502 at the side pillar, a middle pillar sealing assembly at the middle pillar 150.

Specifically, the top pillar 110 of the frame 100 is provided with a top mounting groove, and the top seal 501 may be disposed between the top mounting groove and a top edge of the laminated glass. By disposing the top seal 501 at the top mounting groove, the sealing between the top pillar 110 and the outer glass pane 200 and between the top pillar 110 and the inner glass pane 300 can be ensured when the sliding window is in a closed state.

The side seal 502 may be disposed between the side pillar and the outer glass pane 200 and between the side pillar and the inner glass pane 300. By disposing the side seal 502 at the side pillar, the sealing between the side pillar and the outer glass pane 200 and between the side pillar and the inner glass pane 300 can be ensured when the sliding window is in a closed state. Specifically, the side pillar may be provided with a side mounting groove, and the side seal 502 may be disposed between the side mounting groove and the outer glass pane 200 and between the side mounting groove and the inner glass pane 300.

The top seal 501 and the side seal 502 may be disposed independently, or may be integrally formed, that is, the top seal 501 and the side seal 502 are integrated. For example, for the outer glass pane, its top seal 501 and side seal 502 may be integrated, and for the inner glass pane, its top seal 501 and side seal 502 may also be integrated. Through such integrated arrangement, the joint position between the top seal 501 and the side seal 502 is effectively eliminated, thereby improving sealing performance and reducing water leakage points.

The middle pillar sealing assembly is disposed at a butting position where the outer glass pane 200 and the inner glass pane 300 are butted with each other, so as to seal the gap between the outer glass pane 200 and the inner glass pane 300 when the sliding window is in a closed state.

Referring to FIGS. 6 to 9, specifically, the middle pillar sealing assembly may include a middle pillar seal 503 and a herringbone seal 504, the top pillar 110 is provided with a first middle pillar mounting hole, the bottom pillar 120 is provided with a second middle pillar mounting hole, and two ends of each of the middle pillar 150 and the middle pillar seal 503 are inserted into the first middle pillar mounting hole and the second middle pillar mounting hole, respectively. the middle pillar 150 is provided with two first seal mounting portions 151 in a second direction Y for mounting the middle pillar seal 503, respectively. The second direction Y is perpendicular to the first direction X, and consistent with a thickness direction of the inner glass pane 300 or the outer glass pane 200. At least one side of the middle pillar 150 in the first direction X is provided with a second seal mounting portion 152 for mounting the herringbone seal 504.

In this embodiment, the middle pillar 150 is provided with first seal mounting portions 151 on both sides (an inner side and an outer side) of it in the second direction Y. The first seal mounting portion 151 may be a snap groove for being engaged with the middle pillar seal 503. For example, when the cross-section of the middle pillar seal 503 is generally trapezoidal, the cross-section configuration of the snap groove may also be substantially trapezoidal. The specific configuration of the snap groove may be varied depending on the specific shape of the middle pillar seal 503, which is not specifically limited herein. When the sliding window is in a closed state, the middle pillar seal 503 is in interference fit with the outer glass pane 200 and the inner glass pane 300, respectively.

In this embodiment, the second seal mounting portions 152 may be disposed on both sides of the middle pillar 150 in the first direction X, so that the universality of the middle pillar 150 can be improved, and users can flexibly dispose the second sealing mounting portions 152 at required positions according to actual scenario requirements.

Specifically, the second seal mounting portion 152 may be a snap groove for being engaged with the herringbone seal 504. The specific configuration of the snap groove may be varied depending on the specific configuration of the middle pillar seal 503 and the assembly position thereof, which is not specifically limited herein. For example, a middle part of the herringbone seal 504 is matched with the second seal mounting portion 152, two sealing lips of the herringbone seal 504 extend from the middle part in a direction away from the middle pillar 150, and the distance between the two sealing lips gradually increases in the direction away from the middle pillar 150, that is, the opening between the two sealing lips increases in this direction. When the sliding window is in a closed state, the two sealing lips of the herringbone seal 504 are in interference fit with the outer glass pane 200 and the inner glass pane 300, respectively, thereby achieving an ideal waterproof sealing effect.

In this embodiment, addressing the common problem of poor sealing at the butting position of the outer glass pane 200 and the inner glass pane 300 in existing sliding windows, the present disclosure provides the middle pillar seal 503 and the herringbone seal 504 on the middle pillar 150, so that a first seal is formed between the herringbone seal 504 and the outer glass pane 200 as well as the inner glass pane 300, and a second seal is formed between the middle pillar seal 503 and the outer glass pane 200 as well as the inner glass pane 300. This dual sealing arrangement effectively improves the sealing performance at the middle pillar 150.

Referring to FIGS. 2, 7, 8 and 10, the lower guide mechanism includes an engaging strip disposed on the bottom pillar 120, and the engaging strip extends longitudinally along the first direction X and the top thereof is arc-shaped. The protection mechanism further includes a guide assembly which is disposed on the bottom edge and configured to be matched with the lower guide mechanism. The guide assembly includes a guide groove connector 620 and an end slider 630. The guide groove connector 620 extends longitudinally along the first direction X, a top of the guide groove connector 620 is provided d with a top mounting groove for being matched with the laminated glass, and a bottom of the guide groove connector 620 is provided with a bottom mounting groove. The end slider 630 is detachably disposed in the bottom mounting groove of the guide groove connector 620. A lower end of the end slider 630 is provided with an arc groove engaged with the top of the engaging strip. The end slider 630 is movable along the first direction X relative to the engaging strip.

In this embodiment, for the laminated glass, its two side edges are provided with the encapsulation 610 for protection, its top edge is inserted into the top seal 501, and its bottom edge is provided with the guide assembly, forming a fully circumferential protection for the laminated glass, which effectively reduces the probability of cracking due to impact during sliding of the laminated glass.

In this embodiment, the lower guide mechanism may include the engaging strip disposed on the bottom pillar 120, and the engaging strip may be matched with the guide assembly disposed on the bottom edge of the laminated glass, so that the laminated glass can move along the first direction X under the guidance of the engaging strip.

Specifically, the engaging strip may extend longitudinally along the first direction X, and the top of the engaging strip is arc-shaped.

The guide assembly includes the guide groove connector 620 and the end slider 630. The guide groove connector 620 extends longitudinally along the first direction X, the top of the guide groove connector 620 is provided with a top mounting groove for being matched with the laminated glass, and the bottom of the guide groove connector 620 is provided with a bottom mounting groove.

The end slider 630 is disposed at both ends of the guide groove connector 620, respectively. Specifically, the end slider 630 is detachably disposed in the bottom mounting groove of the guide groove connector 620. The detachable connection may be a threaded connection, for example, the end slider 630 may be connected to the guide groove connector 620 by screws. The height of the end slider 630 may be determined according to the assembly dimensions of the laminated glass and the frame 100, which is not specifically limited herein. The material of the end slider 630 may be different from that of the guide groove connector 620. For example, the end slider 630 may be a plastic piece, and the guide groove connector 620 may be made of an aluminum alloy profile. When the end slider 630 is detachably connected to the guide groove connector 620, it is convenient for subsequent individual disassembly and replacement of the end slider 630.

The lower end of the end slider 630 is provided with an arc groove engaged with the top of the engaging strip, so that when the two arc-shaped structures are fitted, the friction resistance when the glass is pushed or pulled can be effectively reduced.

The inventors of the present disclosure find that in existing sliding windows, the vertical wobble amount of the glass is usually more than 2 mm. As a result, when the sliding window is applied in a vehicle, abnormal noises are likely to occur during the travelling of the vehicle.

In order to effectively solve the above problem, in an embodiment, the lower end of the end slider 630 is provided with a hook 6301 at the position of the arc groove, and the hook 6301 and the top of the engaging strip are clearance-fitted. By utilizing the arc configurations of the hook 6301 and the engaging strip, the fit clearance between them can be controlled within a small range. Under normal circumstances, the fit clearance only needs to meet the requirement that the slider can be mounted between the bottom mounting groove and the engaging strip. Specifically, the movement clearance between the hook 6301 and the top of the engaging strip in the height direction is less than or equal to 0.5 mm, which can effectively reduce the wobble amount of the laminated glass in the height direction and significantly reducing the noise that may be generated by the sliding window. In addition, when the wobble amount of the laminated glass in the height direction is reduced to within 0.5 mm, the movement stroke of the laminated glass is effectively shortened, which is also beneficial to protecting the laminated glass and preventing the laminated glass from cracking due to repeated impacts with a large stroke.

In some application scenarios, for example, when the sliding window is applied in a scenario of high-pressure washing of a vehicle, pressurized water directly impacts the sliding window, and any position with weak sealing in the sliding window may have the possibility of water seepage. In order to effectively drain the water that may seep into the inner side of the sliding window, a drainage passage may be formed on the bottom pillar 120.

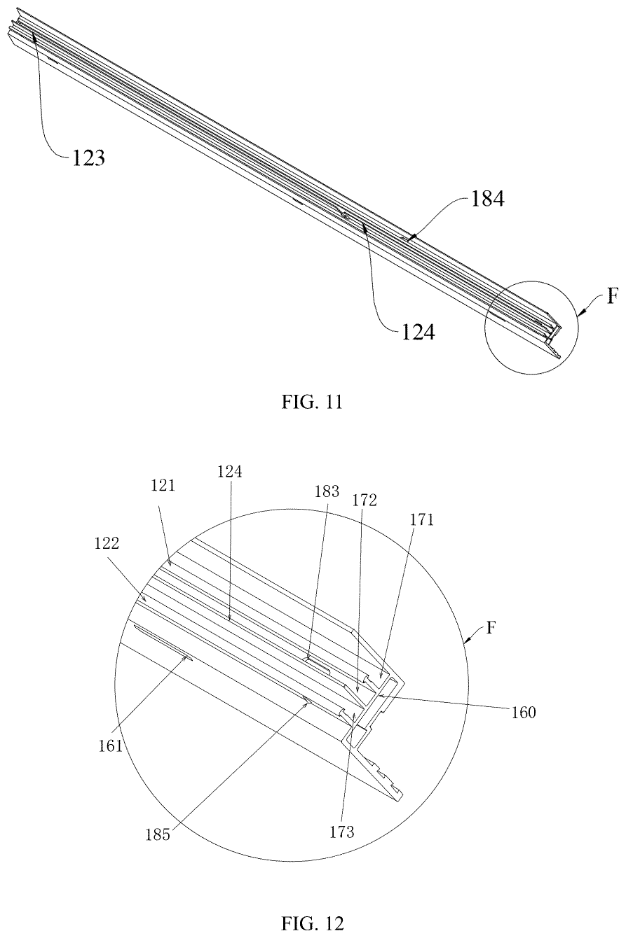

Referring to FIGS. 11, 12, 13, and 14, in some embodiments, a hollow cavity 160 is formed on the bottom pillar 120, and the cavity 160 is provided with a return flow portion for guiding water into the cavity 160 and a drainage hole 161 for guiding water out of the cavity 160. When external water with a predetermined pressure impacts the sliding window, water that seeps into the sliding window can be drained outward through the drainage passage formed by the return flow portion, the cavity 160, and the drainage hole 161.

In this embodiment, the bottom pillar 120 may include the hollow cavity 160, which may have an upper surface close to the laminated glass, a lower surface opposite to the upper surface, and an inner surface and an outer surface which are connected to the upper surface and the lower surface and disposed opposite to each other. The engaging strip is disposed on the upper surface.

The upper surface may be provided with the return flow portion for guiding water that seeps into the sliding window from the outside into the cavity 160. When external water with a predetermined pressure impacts the sliding window, water that seeps into the inner side of the sliding window from the positions with weak sealing can flow to the upper surface by gravity, and then be drained outward sequentially through the return flow portion, the cavity 160, and the drainage hole 161.

The drainage hole 161 is disposed on the outer surface. The drainage hole 161 may be located close to the lower surface of the cavity 160 or directly connected to the lower surface, so that the water in the cavity 160 can be drained outward in time and more thoroughly. There may be a plurality of the drainage holes 161, which may be arranged at intervals along the first direction X. Specifically, the number of the drainage holes 161 may be determined comprehensively according to the size of the sliding window and the configuration of the drainage hole 161, which is not specifically limited herein.

For example, there may be three drainage holes 161. Two of the drainage holes 161 may be disposed close to two ends of the bottom pillar 120, respectively, so as to ensure that when the sliding window is in a non-horizontal position, the drainage hole 161 on either end can drain the water flowing into the cavity 160 outward in time. The other drainage hole 161 may be disposed at the position of the middle pillar 150. The position of the middle pillar 150 is a position where the outer glass pane 200 and the inner glass pane 300 are butted when the sliding window is in a closed state. The position of the middle pillar 150 has a fit clearance, making it a weak sealing position. In order to quickly drain the water seeping here to the outside, the drainage hole 161 may be disposed close to the position of the middle pillar 150, so as to shorten water flow path, improve drainage efficiency, and prevent a small amount of water from accumulating in the bottom pillar 120.

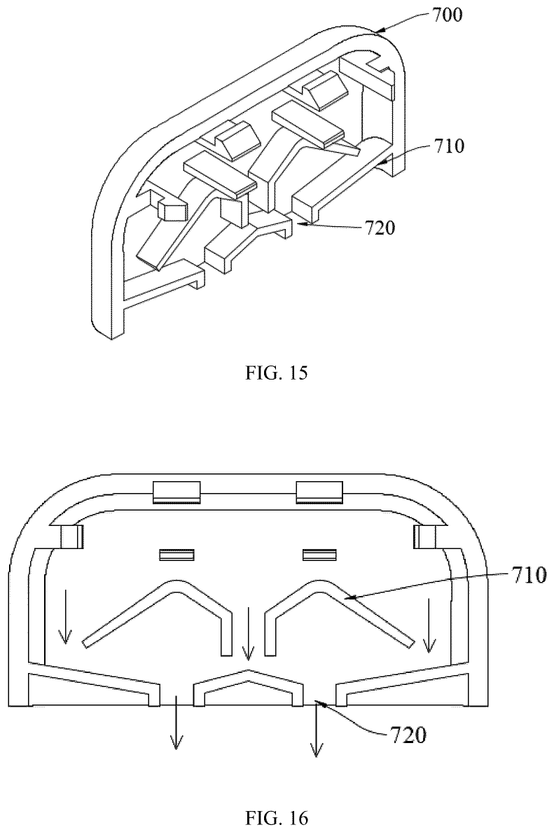

Referring to FIGS. 15 and 16, in an embodiment, the sliding window further includes a cover 700 covering the drainage hole 161. The cover 700 is matched with the bottom pillar 120 to define a non-return passage. The water discharged from the drainage hole 161 flows through the non-return passage and is directed outwardly in a direction away from the drainage hole 161.

In this embodiment, the cover 700 is disposed at the drainage hole 161, to prevent external water from returning upward through the drainage hole 161 along the drainage passage.

Specifically, the cover 700 may be detachably connected to the bottom pillar 120, which is convenient for users to disassemble the cover 700 for internal cleaning or replacement of the cover 700. Specifically, the cover 700 may be made of plastic, which may be made by integral injection molding, thereby reducing the manufacturing cost of the cover 700. However, in this embodiment, the material of the cover 700 is not limited to the above example, and is not uniquely limited herein.

The detachable connection may include snap-fit connection. When the cover 700 is connected to the bottom pillar 120 by snap-fit connection, the inner surface of the cover 700 may be provided with a plurality of snap parts. However, the specific detachable connection may also have other forms, which are not limited herein. Under the inspiration of the technical essence of the present disclosure, persons skilled in the art can make other changes, as long as the achieved functions and effects are the same as or similar to those of the present disclosure, and those changes should fall within the protection scope of the present disclosure.

The inner surface of the cover 700 is provided with a plurality of groups of block structures, which are staggered at intervals along the height direction. The block structure includes sealing block bars 710 which are obliquely disposed, and a drainage outlet 720 is formed between any two adjacent sealing block bars 710 and directly opposite to the sealing block bars 710 located below it.

On the whole, the water discharged from the drainage hole 161 may flow out through the non-return passage by gravity and under guidance of the block structure. In a case where pressurized water impacts the cover 700, even if some water flows upward through the drainage outlet 720 into the non-return passage, since the non-return passage is provided with a plurality of staggered block structures, when the water flows upward and impacts the lower side of the block structures, it will be blocked by the block structures and its flow direction will be changed, and then flows downward along the upper side of the block structures again by gravity.

There is an extension plate extending downward from the outer surface of the cavity 160 on the bottom pillar 120, and the block structures of the cover 700 may cooperate with the extension plate to define the non-return passage. Specifically, the block structure may be attached to the extension plate. The block structure may be in the form of a roof-like drainage slope, or the block structure may include other configurations, which is not specifically limited herein.

Referring to FIGS. 2 and 11, in some embodiments, a baffle is disposed on the bottom pillar 120, and the protection mechanism further includes a guide assembly disposed on the bottom edge and configured to be matched with the lower guide mechanism. The guide assembly includes a guide groove connector 620 which extends longitudinally along the first direction X, and a guide groove seal 505 is disposed between the guide groove connector 620 and the baffle.

In this embodiment, the baffle may be disposed on the bottom pillar 120. Specifically, the baffle may be in the form of a plate with a certain thickness, and the baffle extends longitudinally along the first direction X.

In an embodiment, taking a case where both the outer glass pane 200 and the inner glass pane 300 are slidable along the first direction X in the frame 100 as an example, the side pillar includes a first side pillar 130 and a second side pillar 140 which are disposed opposite to each other. The baffle includes a first baffle 123 and a second baffle 124 which extend longitudinally along the first direction X and are spaced apart from each other. The first baffle 123 has one end close to the first side pillar 130 and the other end close to the middle pillar 150. The second baffle 124 has one end close to the second side pillar 140 and the other end close to the middle pillar 150. When the sliding window is in a closed state, the guide groove connector 620 of the outer glass pane 200 is in interference fit with the first baffle 123 through the guide groove seal 505, and the guide groove connector 620 of the inner glass pane 300 is in interference fit with the second baffle 124 through the guide groove seal 505.

Referring to FIG. 10, a side mounting groove may be disposed on a side of the guide groove connector 620 facing the baffle, the guide groove seal 505 is disposed in the side mounting groove, and the guide groove seal 505 is in interference fit with the baffle. When the laminated glass of the sliding window is sliding, the guide groove seal 505 can move relative to the baffle. In the embodiments of the present disclosure, the baffle may be provided with a mounting groove for mounting the guide groove seal 505. When the guide groove seal 505 is disposed on the baffle, the guide groove connector 620 and the guide groove seal 505 can slide relative to each other. By disposing the baffle and guide groove seal 505, an additional bottom seal is added between the laminated glass and the bottom pillar 120, which can improve the sealing performance therebetween when the sliding window is in a closed state. In addition, during high-pressure washing, the baffle, the guide groove seal 505 and the guide groove connector 620 are in sealing fit, which can prevent external water from directly returning inward through the gap between the guide groove connector 620 and the bottom pillar 120 of the laminated glass.

Taking a case where both the outer glass pane 200 and the inner glass pane 300 are slidable along the first direction X in the frame 100 as an example, the engaging strip may include an outer engaging strip 122 for being matched with the outer glass pane 200, and an inner engaging strip 121 for being matched with the inner glass pane 300. The inner engaging strip 121, the baffle and the outer engaging strip 122 are spaced apart from inside to outside, thereby defining a first groove 171, a second groove 172, and a third groove 173.

Taking a case where the sliding window is applied in a vehicle as an example, when the vehicle undergoes high-pressure washing, washing water may backflow under wind pressure and splash at the return flow portion. As a result, the water may splash in various directions uncontrollably, easily flowing into the vehicle interior and causing a poor user experience. In the embodiments of the present disclosure, the frame 100 itself may form a surrounding structure at the return flow portion, or the frame 100 may be matched with the sealing mechanism to form a surrounding structure at the return flow portion. This surrounding structure prevents water from splashing.

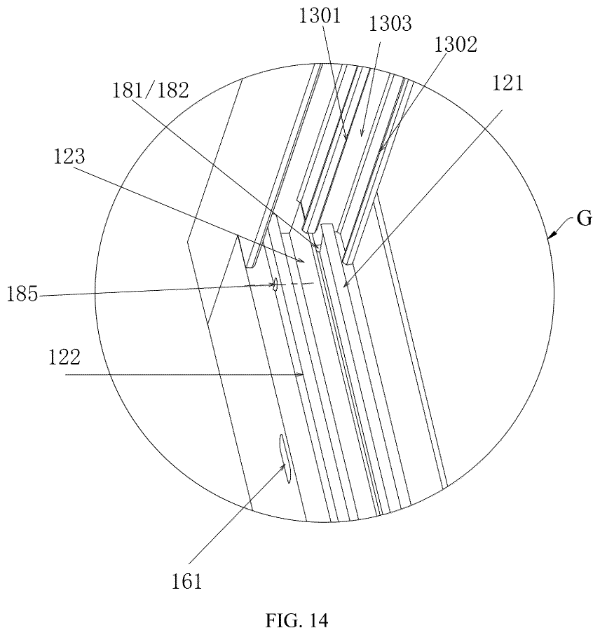

As illustrated in FIGS. 13 and 14, the return flow portion may include a first return flow hole 181 and a second return flow hole 182 which are located on the bottom pillar 120 and at least partially shielded by the first side pillar 130. The first return flow hole 181 communicates the first groove 171 with the cavity 160, and the second return flow hole 182 communicates the second groove 172 with the cavity 160.

In this embodiment, the return flow portion may include the first return flow hole 181 that communicates the first groove 171 with the cavity 160 and athe second return flow hole 182 that communicates the second groove 172 with the cavity 160. The first return flow hole 181 and the second return flow hole 182 may be separately disposed at different positions, or they may be disposed at the same position. The first return flow hole 181 and the second return flow hole 182 may both be disposed on the bottom pillar 120. Specifically, the first return flow hole 181 and the second return flow hole 182 both penetrate the upper surface of the cavity 160. Due to an ingenious design of the positions of the first return flow hole 181 and the second return flow hole 182, they can be shielded by the first side pillar 130. During high-pressure washing, if water backflows from the first return flow hole 181 and the second return flow hole 182, the first side pillar 130 can be used for shielding. The water, upon impacting the first side pillar 130, it can flow downward by gravity, and then be drained outward along the drainage passage, without splashing into the vehicle.

As illustrated in FIG. 14, further, the first return flow hole 181 and the second return flow hole 182 are integrally formed as a communication hole on the upper surface of the cavity 160, and the communication hole is enclosed in a surrounding structure formed by the first side pillar 130 and the inner engaging strip 121.

In this embodiment, the first return flow hole 181 and the second return flow hole 182 may be integrally formed as a communication hole. Specifically, the integral formation may be achieved by hole milling or any other way, which is not specifically limited herein.

When the first return flow hole 181 and the second return flow hole 182 form as the communication hole, the production and processing efficiency can be improved, and the machining cost can be reduced. Further, the communication hole may be disposed below the inner engaging strip 121, such as a U-shaped groove disposed below the inner engaging strip 121. The cooperation between the inner engaging strip 121 and the first side pillar 130 can further enhance the shielding effect on water splashing upward from the communication hole.

Specifically, the first side pillar 130 includes a first extension wall 1301 and a second extension wall 1302 that protrude toward the second side pillar 140, and a side bottom wall 1303 which connects the first extension wall 1301 and the second extension wall 1302. One end of the communication hole extends to the side bottom wall 1303, and the communication hole is located between the first extension wall 1301 and the second extension wall 1302.

In which, at least part of the inner engaging strip 121 may be located right above the communication hole. The width of the communication hole may be equal to or slightly smaller than that of the inner engaging strip 121, so that the water splashing out of the communication hole can be mainly blocked by the inner engaging strip 121, and a small amount of water splashing around can be contained by the first extending wall 1301, the second extending wall 1302 and the side bottom wall 1303.

In addition, in another embodiment, the first side pillar 130 may also be provided with a fourth extension wall (not illustrated), a projection of which toward the communication hole at least partially covers the communication hole. The fourth extension wall cooperates with the first extension wall 1301, the second extension wall 1302 and the side bottom wall 1303, so as to more reliably contain the water splashing out of the communication hole.

Referring to FIG. 10, in an embodiment, the return flow portion may further include a third return flow hole 183 located on the bottom wall of the second groove 172 and disposed close to the second side pillar 140. The third return flow hole 183 is enclosed in the surrounding structure formed by the guide groove seal 505, the baffle (the second baffle 124 as illustrated) and the inner engaging strip 121.

In this embodiment, in order to improve the drainage performance of the sliding window, a third return flow hole 183 may be disposed on the bottom wall of the second groove 172 close to the second side pillar 140. In this way, either end of the sliding window is provided with a drainage structure in the first direction X, which can improve the outward drainage efficiency of the sliding window, while ensuring that no water accumulation occurs at either end of the bottom pillar 120 when the bottom pillar 120 of the sliding window is in a non-horizontal position.

In addition, due to the surrounding structure formed by the guide groove seal 505, the second baffle sheet 124 and the inner engaging strip 121, the third return flow hole 183 can be shielded to prevent backflow water from splashing inward.

In a specific scenario, taking a case where the sliding window is applied in a vehicle as an example, when the vehicle undergoes high-pressure washing, washing water may backflow under wind pressure. Specifically, the backflow water may come from multiple directions. As mentioned above, due to the sealing fit between the baffle and the guide groove connector 620 through the guide groove seal 505, external water can be prevented from back flowing inward through the clearance between the guide groove connector 620 and the bottom pillar 120 of the laminated glass. In addition, during high-pressure washing of the vehicle, a small amount of water may splash at the third return flow hole 183 after passing through the drainage hole 161 and the cavity 160 under wind pressure. However, in this embodiment, since the third return flow hole 183 is disposed on the bottom wall of the second groove 172, at the two sides of the third return flow hole 183, water is blocked by the second baffle 124 and the inner engaging strip 121, respectively, and at the top of the third return flow hole 183, water is blocked by the guide groove seal 505 disposed between the baffle and the guide groove connector 620, forming a closed surrounding structure around the third return flow hole 183, thereby reliably ensuring that the water flowing out of the third return flow hole 183 can be effectively contained. The contained water can flow downward by gravity and then be drained outward along the drainage passage without splashing into the vehicle.

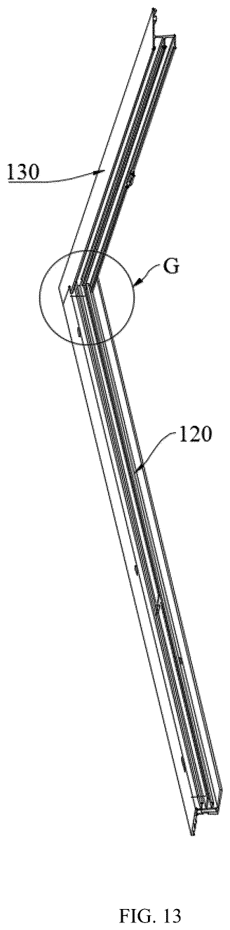

As illustrated in FIGS. 11 and 12, in an embodiment, the return flow portion may further include a fourth return flow hole 184 located on a bottom wall of the first groove 171.

In this embodiment, the return flow portion may further include the fourth return flow hole 184 disposed on the first groove 171. Under normal circumstances, the first groove 171 is located on the inner side of the laminated glass and may directly opposite to the laminated glass (e.g., the inner glass pane 300). By disposing the sealing mechanism, etc. in the above embodiments, external water can be prevented from flowing to the inner side of the laminated glass.

In certain scenarios, when the sliding window is in a high-pressure washing state, the fourth return flow hole 184 may be used to drain external water, which seeps inward along the sealing mechanism of the sliding window, to the outside through the drainage passage. Specifically, when the sealing mechanism of the sliding window partially fails due to aging or other reasons, external water may seep into the inner side of the sliding window through the sealing mechanism. The seeped water subsequently flows downward by gravity, converges into the first groove 171 of the bottom pillar 120, and then is discharged outward through the drainage passage.

As illustrated in FIG. 11, further, in the first direction X, the fourth return flow hole 184 and the third return flow hole 183 are staggered with the drainage hole 161.

In this embodiment, in order to extend the drainage path of the drainage passage and increase the flow resistance to the backflow water, the drainage hole 161 may be arranged staggered with the fourth return flow hole 184 and the third return flow hole 183 on the bottom pillar 120.

Considering that the splash-proof surrounding structure is disposed at the third return flow hole 183, the distance between the fourth return flow hole 184 and the drainage hole 161 in the first direction X may be greater than the distance between the third return flow hole 183 and the drainage hole 161, so as to prioritize guiding the backflow water to the third return flow hole 183. During high-pressure washing, the backflow water preferentially flows through a water flow passage with a shorter flow path, that is, the backflow water preferentially flows into the third return flow hole 183 after passing through the cavity 160. Since the surrounding structure is disposed at the third return flow hole 183, it can prevent the backflow water from splashing to the inner side of the sliding window.

As illustrated in FIGS. 11 and 12, in an embodiment, the outer engaging strip 122 is provided with a water accumulation hole 185 at a position close to a bottom wall of the third groove 173.

In the embodiments of the present disclosure, the water accumulation hole 185 communicated with the outside may be disposed at the position of the outer engaging strip 122 close to the bottom wall of the third groove 173. For example, in a case where the sliding window is applied in a vehicle, when the vehicle is travelling in a rainy day or is washed, when water flows into the third groove 173, it accumulates in the third recess 173 and then overflows out of the vehicle. When the water inflow stops, the water in the third groove 173 can be drained outward through the water accumulation hole 185. Specifically, there may be two water accumulation holes 185, which may be disposed close to both ends of the outer engaging strip 122, respectively, facilitating reliable outward drainage of the accumulated water in the third groove 173.

The sliding window according to the embodiments of the present disclosure overcomes the technical barrier of the laminated glass. By using the laminated glass with better noise reduction performance as the glass of the sliding window, the noise reduction performance of the sliding window can be enhanced, and the user experience can be improved. In addition, by disposing the protection mechanism at the periphery of the laminated glass, the laminated glass is effectively protected to reduce the risk of cracking.

By disposing the encapsulation 610 for the side edge of the laminated glass, not only the laminated glass can be effectively protected, but also the use reliability of the laminated glass can be improved to reduce the risk of cracking. Meanwhile, the window locking mechanism 400 of the laminated glass is ingeniously disposed through the encapsulation 610, which overcomes the technical obstacles that the laminated glass cannot be punched and the window locking mechanism 400 cannot be disposed in the prior art.

By improving the matching structure between the frame 100 and the laminated glass, the movement gap of the laminated glass in the height direction is reduced to be within 0.5 mm, so that the wobble amount of the laminated glass in the height direction can be effectively decreased, and the noise that may be generated by the sliding window can be effectively reduced. In addition, when the wobble amount of the laminated glass in the height direction is reduced to less than 0.5 mm, the movement stroke of the laminated glass is effectively shortened, which is also beneficial to protecting the laminated glass and preventing the laminated glass from cracking due to repeated impacts with a large stroke.

In addition, in the embodiments of the present disclosure, by optimizing and improving the sealing mechanism and the drainage passage in the sliding window, it is possible to further enhance the sealing performance of the sliding window, while achieving effective drainage in the scenarios of high-pressure washing and preventing the backflow water from splashing into the vehicle when the water backflows under the action of wind pressure. On the whole, when the sliding window according to the embodiments of the present disclosure undergoes high-pressure washing, the high-pressure washing resistance can be above 6 MPa.

The embodiments of the present disclosure further provide a vehicle, which mainly includes a body sheet metal and the aforementioned sliding window. The body sheet metal is provided with a sliding window mounting opening where the sliding window is mounted. By being equipped with the sliding window, the vehicle can achieve the technical effects realized by the embodiments of the sliding window. For details, please refer to the specific description of the above embodiments, which will not be repeated herein.

It should be noted that in the description of the present disclosure, the terms “first”, “second”, etc. are only used to describe the purposes and distinguish similar objects, and there is no sequence of priority therebetween, nor can they be understood as indicating or implying relative importance. In addition, in the description of the present disclosure, unless otherwise specified, “a plurality of” means two or more.

The embodiments of the present disclosure are all described in a progressive manner, and the same or similar parts of the embodiments can refer to each other. Each embodiment lays an emphasis on its distinctions from other embodiments.

Those described above are only a few embodiments of the present disclosure. Although the embodiments disclosed in the present disclosure are described as above, they are only those adopted for the convenience of understanding the present disclosure, rather than limiting the present disclosure. Persons skilled in the art can make any modification or change in the form and details of the embodiments without departing from the spirit and the scope revealed by the present disclosure, but the patent protection scope of the present disclosure should still be subject to the scope defined in the appended claims.

1. A sliding window, comprising:
a frame, which is a circumferentially closed surrounding frame structure; and
an outer glass pane and an inner glass pane which are mounted in the frame, at least one selected from the inner glass pane and the outer glass pane being slidable in the frame;
wherein the inner glass pane and/or the outer glass pane slidable in the frame is a laminated glass;
the laminated glass comprises an outer glass plate, an intermediate layer and an inner glass plate which are sequentially stacked; and
an edge of the laminated glass is provided with a protection mechanism.

2. The sliding window according to claim 1, wherein the edge of the laminated glass comprises:
a top edge and a bottom edge opposite to each other, and a side edge connected to the top edge and the bottom edge; and
the protection mechanism comprises an encapsulation that wraps the side edge.

3. The sliding window according to claim 2, wherein the encapsulation is fixed on the side edge of the laminated glass by adhesion, and the encapsulation comprises one or more selected from a metal encapsulation, an injection-molded encapsulation and a rubber encapsulation.

4. The sliding window according to claim 2, further comprising a window locking mechanism, which is connected to the laminated glass through the encapsulation.

5. The sliding window according to claim 4, wherein the window locking mechanism comprises a locking body and a connector; and
the locking body comprises a locking block, which is connected to the encapsulation through the connector.

6. The sliding window according to claim 5, wherein the laminated glass is provided with an adhesive layer of a predetermined size at a position close to the encapsulation, part of the locking block is connected to the adhesive layer, another part of the locking block extends to the encapsulation, and a hole for being matched with the connector is formed at positions of the locking block and the encapsulation that are overlapped with each other.

7. The sliding window according to claim 1, wherein the frame comprises a top pillar and a bottom pillar opposite to each other, and a side pillar connecting the top pillar and the bottom pillar;
the sliding window further comprises a sealing mechanism for sealing between the laminated glass and the frame, the top pillar of the frame is provided with a top mounting groove, and the side pillar is provided with a side mounting groove; and
the sealing mechanism comprises: a top seal disposed between the top mounting groove and a top edge of the laminated glass, and a side seal disposed between the side mounting groove and a side edge of the laminated glass.

8. The sliding window according to claim 7, wherein the frame further comprises a middle pillar, and the sealing mechanism further comprises a middle pillar sealing assembly,
the middle pillar sealing assembly is disposed at a butting position between the outer glass pane and the inner glass pane, to seal a gap between the outer glass pane and the inner glass pane when the sliding window is in a closed state.

9. The sliding window according to claim 8, wherein the middle pillar sealing assembly comprises a middle pillar seal and a herringbone seal;
the top pillar is provided with a first middle pillar mounting hole, the bottom pillar is provided with a second middle pillar mounting hole, and two ends of each of the middle pillar and the middle pillar seal are inserted into the first middle pillar mounting hole and the second middle pillar mounting hole, respectively;
the middle pillar is provided with two first seal mounting portions in a second direction for mounting the middle pillar seal, respectively, and the second direction is consistent with a thickness direction of the inner glass pane or the outer glass pane; and
at least one side of the middle pillar in a first direction is provided with a second seal mounting portion for mounting the herringbone seal.

10. The sliding window according to claim 1, wherein the frame comprises a top pillar and a bottom pillar opposite to each other, and a side pillar connecting the top pillar and the bottom pillar;
the bottom pillar is provided with a lower guide mechanism for guiding movement of the laminated glass; and
the laminated glass is slidable along an extension direction, which is a first direction, of the bottom pillar under guidance of the lower guide mechanism.

11. The sliding window according to claim 10, wherein the lower guide mechanism comprises an engaging strip disposed on the bottom pillar and extending longitudinally along the first direction, and a top of the engaging strip is arc-shaped;
the protection mechanism further comprises a guide assembly which is disposed on a bottom edge of the laminated glass and configured to be matched with the lower guide mechanism, and the guide assembly comprises a guide groove connector and an end slider;
the guide groove connector extends longitudinally along the first direction, a top of the guide groove connector is provided with a top mounting groove for being matched with the laminated glass, and a bottom of the guide groove connector is provided with a bottom mounting groove;
the end slider is detachably disposed in the bottom mounting groove of the guide groove connector, and a lower end of the end slider is provided with an arc groove engaged with the top of the engaging strip; and
the end slider is movable along the first direction relative to the engaging strip.

12. The sliding window according to claim 11, wherein the lower end of the end slider is provided with a hook at a position of the arc groove, the hook and the top of the engaging strip are clearance-fitted, and a movement clearance between the hook and the top of the engaging strip in a height direction is less than or equal to 0.5 mm.

13. The sliding window according to claim 1, wherein the frame comprises a bottom pillar provided with a hollow cavity, and the cavity is provided with a return flow portion for guiding water into the cavity and a drainage hole for draining water out of the cavity; and
the return flow portion, the cavity and the drainage hole are communicated to form a drainage passage.

14. The sliding window according to claim 13, wherein the cavity has an outer surface exposed to the outside, the drainage hole is disposed on the outer surface, the sliding window further comprises a cover covering the drainage hole, and the cover cooperates with the bottom pillar to define a non-return passage, so that the water discharged from the drainage hole flows through the non-return passage and is directed outwardly in a direction away from the drainage hole.

15. The sliding window according to claim 14, wherein an inner surface of the cover is provided with a plurality of groups of block structures, which are staggered at intervals along a height direction; and
the block structure comprises sealing block bars which are obliquely disposed, and a drainage outlet is formed between any two adjacent sealing block bars and directly opposite to the sealing block bar located below it.

16. The sliding window according to claim 13, wherein the bottom pillar is provided with a lower guide mechanism for guiding movement of the laminated glass;
the bottom pillar is provided with a baffle, and the protection mechanism further comprises a guide assembly disposed on a bottom edge of the laminated glass for being matched with the lower guide mechanism;
the guide assembly comprises a guide groove connector which extends longitudinally along a first direction, and a guide groove seal is disposed between the guide groove connector and the baffle.

17. The sliding window according to claim 16, wherein a side mounting groove is disposed on a side of the guide groove connector facing the baffle, the guide groove seal is disposed in the side mounting groove, and the guide groove seal is in interference fit with the baffle.

18. The sliding window according to claim 17, wherein both the outer glass pane and the inner glass pane are slidable along the first direction in the frame, the frame comprises side pillars that include a first side pillar and a second side pillar disposed opposite to each other, and the frame further comprises a middle pillar located between the first side pillar and the second side pillar;
the baffle comprises a first baffle and a second baffle which extend longitudinally along the first direction and are spaced apart from each other;
the first baffle has one end close to the first side pillar and the other end close to the middle pillar, and the second baffle has one end close to the second side pillar and the other end close to the middle pillar; and
when the sliding window is in a closed state, the first baffle is directly opposite to the guide groove connector of the outer glass pane through the guide groove seal, and the second baffle is directly opposite to the guide groove connector of the inner glass pane through the guide groove seal.

19. The sliding window according to claim 18, wherein the lower guide mechanism comprises an engaging strip disposed on the bottom pillar, the engaging strip comprises an outer engaging strip for being matched with the outer glass pane and an inner engaging strip for being matched with the inner glass pane;
the inner engaging strip, the baffle and the outer engaging strip are spaced apart from inside to outside to define a first groove, a second groove, and a third groove;
the return flow portion comprises a first return flow hole and a second return flow hole which are located on the bottom pillar and at least partially shielded by the first side pillar, wherein the first return flow hole communicates the first groove with the cavity, and the second return flow hole communicates the second groove with the cavity.

20. A vehicle, comprising a body sheet metal and a sliding window, wherein the body sheet metal is provided with a sliding window mounting opening where the sliding window is mounted;
wherein the sliding window comprises:
a frame, which is a circumferentially closed surrounding frame structure; and
an outer glass pane and an inner glass pane which are mounted in the frame, at least one selected from the inner glass pane and the outer glass pane being slidable in the frame;
wherein the inner glass pane and/or the outer glass pane slidable in the frame is a laminated glass;
the laminated glass comprises an outer glass plate, an intermediate layer and an inner glass plate which are sequentially stacked; and
an edge of the laminated glass is provided with a protection mechanism.
